(19) United States
(12) Patent Application Publication
(10) Pub. No.: US 2018/0070008 A1
(43) Pub. Date: Mar. 8, 2018

(54) TECHNIQUES FOR USING LIP MOVEMENT DETECTION FOR SPEAKER RECOGNITION IN MULTI-PERSON VIDEO CALLS

(71) Applicant: QUALCOMM Incorporated, San Diego, CA (US)

(72) Inventors: Rashi TYAGI, Hyderabad (IN); Siva Ramesh Kumar ANDEY, Hyderabad (IN); Chinna Lakshman PARA, Hyderabad (IN)

(21) Appl. No.: 15/260,013

(22) Filed: Sep. 8, 2016

(51) Int. Cl. H04N 5/232; H04N 7/15; G06K 9/00; H04N 5/268

(52) U.S. Cl. CPC H04N 5/23219; H04N 7/15; H04N 5/268; H04N 5/23296; G06K 9/00335

(57) ABSTRACT

Certain aspects of the present disclosure generally relate to using lip movement detection for speaker recognition in multi-person video calls. In some aspects, a device may determine a parameter associated with lip movement of a participant included in a plurality of participants on a same end of a video call. The device may compare the parameter to a threshold. The device may initiate a change in a focus associated with a video feed of the video call based at least in part on the comparison of the parameter to the threshold.

### FIELD OF THE DISCLOSURE

Aspects of the present disclosure generally relate to techniques for speaker recognition, and more particularly to techniques for using lip movement detection for speaker recognition in multi-person video calls.

### BACKGROUND

Speaker recognition may refer to identifying a person who is speaking during a video call. For example, during a video call, computing devices at either end of the call may detect audio signals (e.g., using a microphone) to determine which end of the video call has an active speaker, and may output a video feed from that end of the video call for display. This and other speaker recognition techniques may be used to improve a video call experience by allowing video call participants to see the face, movement, gestures, etc. of a person who is speaking during the video call.

### SUMMARY

In some aspects, a method may include determining, by a device, a parameter associated with lip movement of a participant included in a plurality of participants on a same end of a video call. The method may include comparing, by the device, the parameter to a threshold. The method may include initiating, by the device, a change in a focus associated with a video feed of the video call based at least in part on the comparison of the parameter to the threshold.

In some aspects, a device may include one or more processors to determine a parameter associated with lip movement of a participant included in a plurality of participants on a same end of a video call. The one or more processors may compare the parameter to a threshold. The one or more processors may initiate a change in a focus associated with a video feed of the video call based at least in part on the comparison of the parameter to the threshold.

In some aspects, a non-transitory computer-readable medium may store one or more instructions that, when executed by one or more processors of a device, cause the one or more processors to determine a parameter associated with lip movement of a participant included in a plurality of participants on a same end of a video call. The one or more instructions may cause the one or more processors to compare the parameter to a threshold. The one or more instructions may cause the one or more processors to initiate a change in a focus associated with a video teed of the video call based at least in part on the comparison of the parameter to the threshold.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which techniques described herein may be implemented, in accordance with various aspects of the present disclosure.

FIG. 2 is a diagram illustrating example components of one or more devices shown in FIG. 1, such as a video camera or a communication device, in accordance with various aspects of the present disclosure.

FIGS. 3-8 are diagrams illustrating an example of using lip movement detection for speaker recognition in multi-person video calls, in accordance with various aspects of the present disclosure.

FIG. 9 is a diagram illustrating an example process for using lip movement detection for speaker recognition in multi-person video calls, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details.

During a video call, a user experience may be enhanced by displaying an image or video feed of a video call participant that is currently speaking. In this way, the user may be able to determine who is speaking, may be able to see the speaker's facial expressions, may be able to better understand the speaker, or the like. In some cases, audio may be used to determine which end of a video call has an active speaker. For example, when sound is detected on a first end of a video call, a communication device (e.g., a computer, a mobile phone, etc.) may output a video teed from a video camera positioned on the first end of the video call, and when sound is detected on a second end of a video call, the communication device may output a video feed from a video camera positioned on the second end of the video call. In this way, a video feed of an active speaker may be output.

However, in situations where there are multiple participants on the same end of the video call, such audio detection techniques may only be able to determine which end of the call has an active speaker, and not which participant (of the multiple participants) is the active speaker. Aspects described herein use lip movement detection to determine which participant, among multiple participants on the same end of a video call, is the active speaker, and may use this determination to change focus of a camera to the active speaker. In this way, a user experience associated with the video call may be enhanced, such as by enabling a user to determine who is speaking, to see the speaker's facial expressions, to better understand the speaker, or the like. Furthermore, by focusing on the active speaker, video or image processing techniques associated with speaker recognition may be improved.

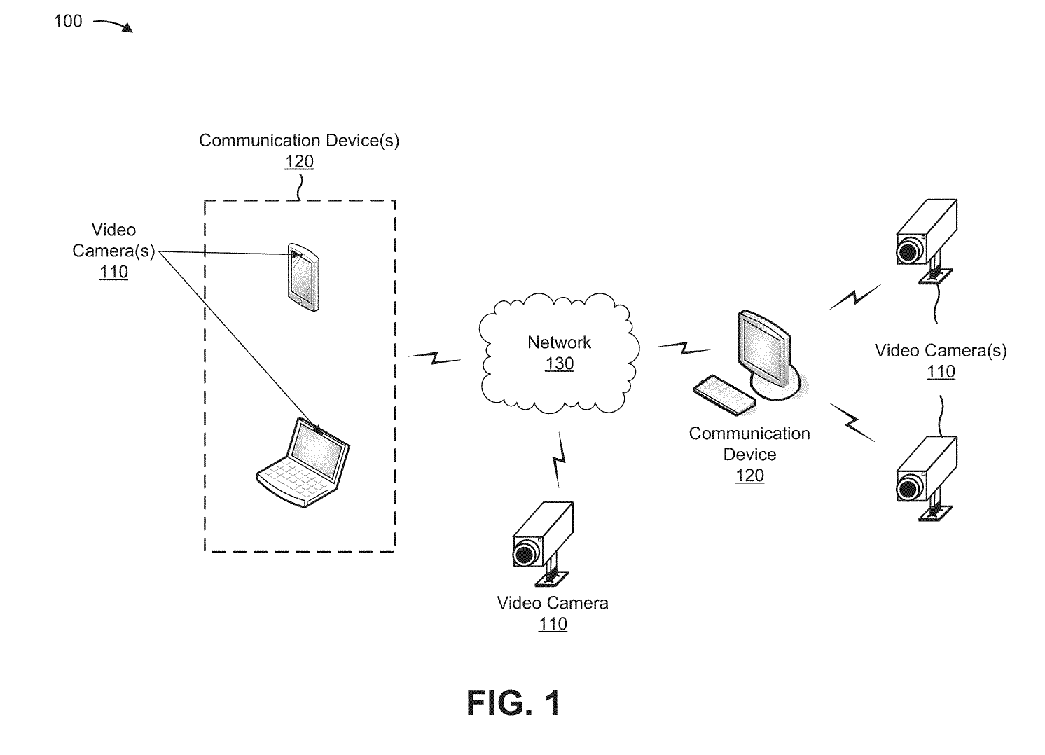

FIG. 1 is a diagram illustrating an example environment 100 in which techniques described herein may be implemented, in accordance with various aspects of the present disclosure. As shown in FIG. 1, environment 100 may include one or more video cameras 110, one or more communication devices 120, and a network 130. Devices of environment 100 may interconnect via wired connections, wireless connections, or a combination of wired and wireless connections.

Video camera 110 includes one or more devices capable of capturing a video, such as a video feed for a video call. For example, video camera 110 may include a webcam, an Internet protocol (IP) camera, a digital video camera, a camcorder, a pan-tilt-zoom (PTZ) camera, or the like. In some aspects, video camera 110 may be incorporated into communication device 120 (e.g., via built-in hardware). In some aspects, video camera 110 may be separate from communication device 120, and may communicate with communication device 120 via a wired connection (e.g., a universal serial bus (USB) connection, an Ethernet connection, etc. and/or a wireless connection (e.g., a Wi-Fi connection, a near field communication (NFC) connection, etc.). In some aspects, video camera 110 may include audio input (e.g., a microphone) to capture speech of participants on a video call.

Communication device 120 includes one or more devices capable of transmitting data from video camera 110 (e.g., a video feed) to one ore other communication devices 120, such as for a video call. For example, communication device 120 may include a desktop computer, a laptop computer, a tablet computer a server computer, a mobile phone, a gaming device, a television, a wearable communication device (e.g., a smart wristwatch, a pair of smart eyeglasses, a smart band, smart clothing, etc.), or a similar type of device. In some aspects, communication device 120 may execute a video call application to permit communication among communication devices 120 via a video call. In some aspects, communication device 120 may include audio input (e.g., a microphone) to capture speech of participants on a video call.

In some aspects, communication devices 120 may communicate via a video call server to connect on and conduct a video call. While some techniques are described herein as being performed by communication device 120, these techniques may be performed by the video call server, a combination of communication device 120 and the video call server, a combination of video camera 110 and communication device 120, a combination of video camera 110 and the video call server, a combination of video camera 110, communication device 120, and the video call server, or some other combination of devices.

Network 130 includes one or more wired and/or wireless networks. For example, network 130 may include a cellular network (e.g., a long-term evolution (LTE) network, a fourth generation (4G) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. In some aspects, when two or more devices shown in FIG. 1 are implemented within a single device, the two or more devices may communicate via a bus. Additionally, or alternatively, a set of devices (e.g., one or more devices) of environment 100 may perform one or more functions described as being performed by another set of devices of environment 100.

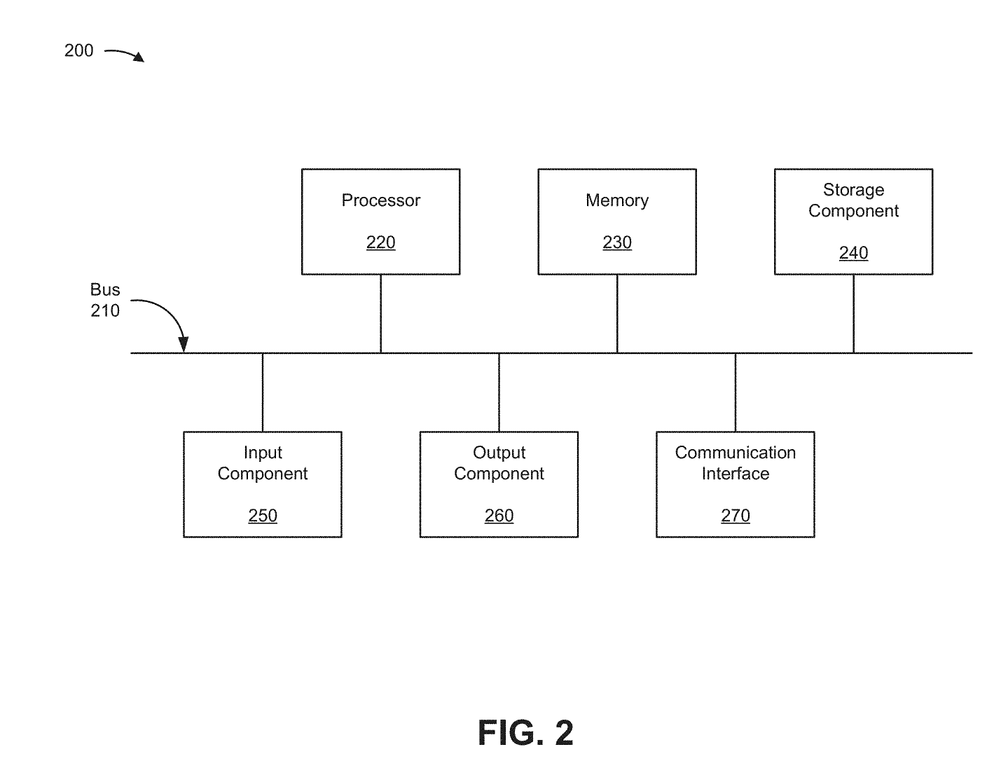

FIG. 2 is a diagram of example components of a device 200. Device 200 may correspond to video camera 110 and/or communication device 120. In some aspects, video camera 110 and/or communication device 120 may include one or more devices 200 and/or one or more components of device 200. As shown in FIG. 2, device 200 may include a bus 210, a processor a memory 230, a storage component 240, an input component 250, an output component 260, and a communication interface 270.

Bus 210 includes a component that permits communication among the components of device 200. Processor 220 includes a processor (e.g., a central processing unit (CPU), a graphics processing unit (GPU), an accelerated processing unit (APU), and/or a digital signal processor (DSP)), a microprocessor, a microcontroller, and/or any processing component (e.g., a field-programmable gate array (FPGA) and/or an application-specific integrated circuit (ASIC)) that interprets and/or executes instructions. Processor 220 is implemented in hardware, firmware, or a combination of hardware and software. In some aspects, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits device 200 to receive information, such as via user input (e.g., a touch screen display, a keyboard, a keypad, a mouse, a button, a switch, and/or a microphone). Additionally, or alternatively, input component 250 may include a sensor for sensing information (e.g., an image sensor, a global positioning system (GPS) component, an accelerometer, a gyroscope, and/or an actuator). Additionally, or alternatively, input component 250 may include a video capture component for capturing an image feed. Output component 260 includes a component that provides output from device 200 (e.g., a display, a speaker, and/or one or more light-emitting diodes (LEDs)).

Communication interface 270 includes a transceiver and/or a separate receiver and transmitter that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus USB interface, a Wi-Fi interface, a cellular network interface, a wireless modern, an inter-integrated circuit (I²C), a serial peripheral interface (SPI), or the like.

Device 200 may perform one or more processes described herein. Device 200 may perform these processes in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

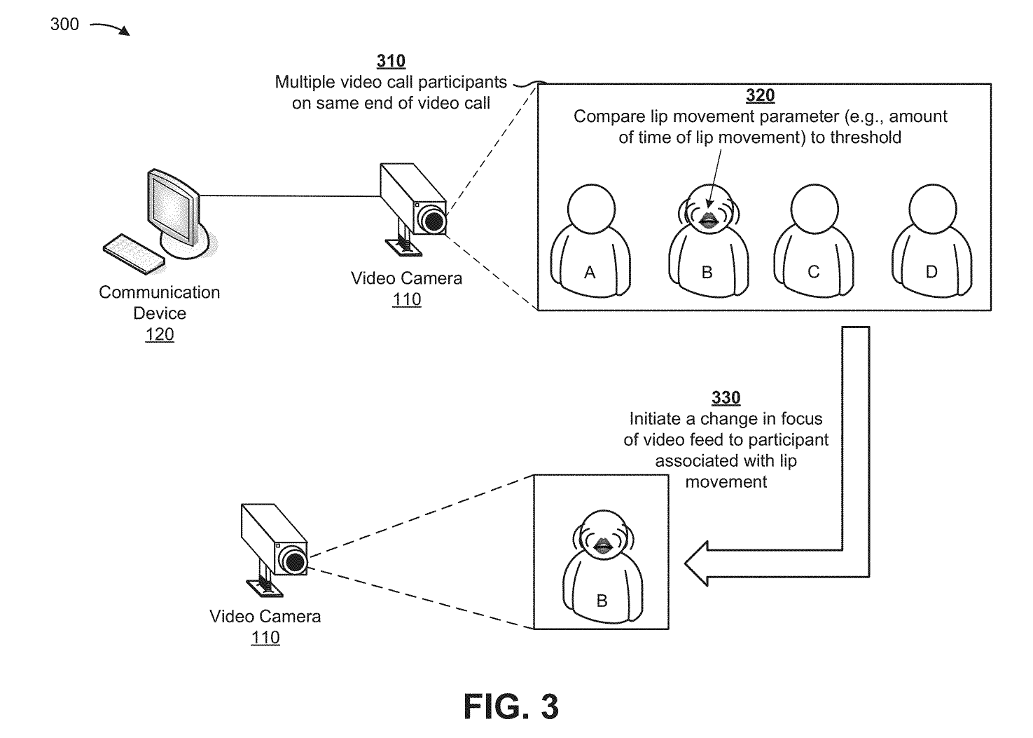

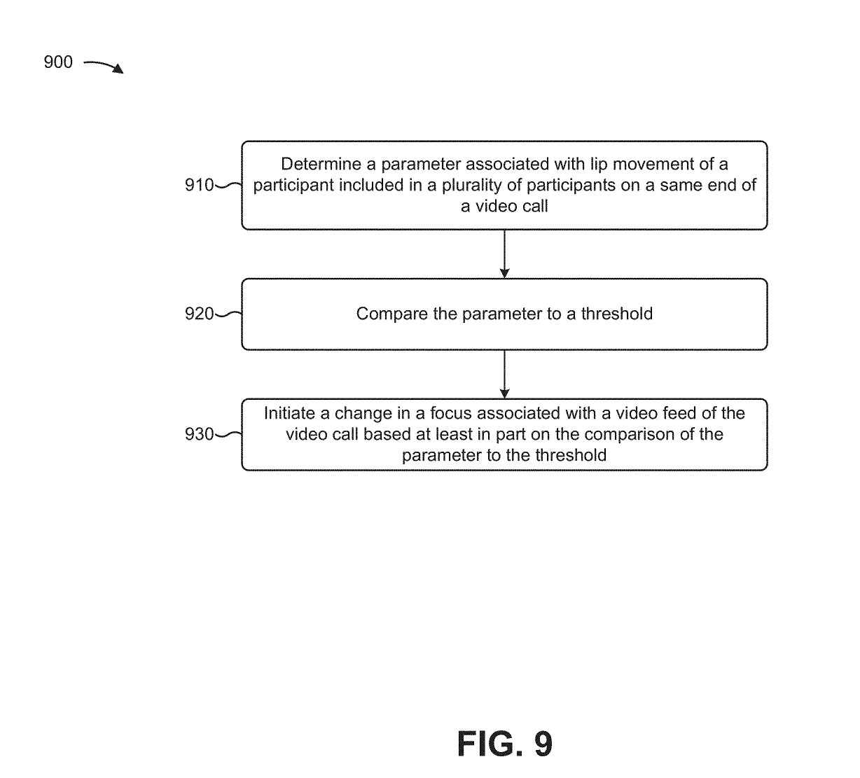

In some aspects, device 200 includes means for performing one or more processes described herein and/or means for performing one or more steps of the processes described herein, such as process 900 of FIG. 9 and/or one or more other processes described herein (e.g., in FIGS. 3-8). For example, the means for performing the processes and/or steps described herein may include bus 210, processor 220, memory 230, storage component 240, input component 250, output component 260, communication interface 270, or any combination thereof.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

FIG. 3 is a diagram illustrating an example 300 of using lip movement detection for speaker recognition in multi-person video calls, in accordance with various aspects of the present disclosure.

As shown in FIG. 3, video camera 110 may capture a video feed, and may communicate with communication device 120. For example, video camera 110 may provide the video feed (and/or video data for the video feed) to communication device 120. Communication device 120 may provide video data to another communication device 120, via a network, for a video call.

As shown by reference number 310, communication device 120 may communicate with video camera 110 to obtain video data of a video feed that includes multiple video call participants on the same end of a video call. In some aspects, communication device 120 may detect multiple participants on the same end of the video call. For example, communication device 120 may use facial recognition, speech recognition, or another technique to detect multiple participants on the same end of the video call. In some aspects, communication device 120 may prevent the techniques described below from being implemented unless multiple participants are detected on the same end of the video call, thereby conserving computing resources. Additionally, or alternatively, communication device 120 may transmit a video feed to a video call server, and the video call server may detect the multiple participants and/or perform one or more other techniques described herein.

As shown by reference number 320, communication device 120 may determine a parameter associated with lip movement (i.e., a lip movement parameter) of a participant of the multiple participants, and may compare the lip movement parameter to a threshold. In some aspects, the lip movement parameter may represent an amount of time of the lip movement of the participant. Additionally, or alternatively, the lip movement parameter may represent a measure of an amount of lip movement of the participant. In this case, communication device 120 may determine the measure of the amount of lip movement based at least in part on, for example, a lip movement recognition algorithm.

In some aspects, communication device 120 may compare the lip movement parameter to a threshold. For example, communication device 120 may determine whether the amount of time of lip movement satisfies a threshold (e.g., may determine whether the participant's lips have been moving for a threshold amount of time). As another example, communication device 120 may determine whether a measure of an amount of lip movement satisfies a threshold (e.g., may determine whether the degree to which the participant's lips are moving satisfies the threshold). In some aspects, communication device 120 may calculate a score based at least in part on multiple factors (e.g., an amount of time of lip movement, a measure of an amount of lip movement, etc.), and may determine whether the score satisfies the threshold.

As shown by reference number 330, if communication device 120 determines that the lip movement parameter satisfies the threshold, then communication device 120 may initiate a change in a focus of the video feed. For example, communication device 120 may initiate the change in the focus of the video feed by providing an instruction to video camera 110 to change the focus (e.g., to pan video camera 110, to zoom video camera 110, to tilt video camera 110, to switch to a different video camera 110, or the like). As shown, communication device 120 may initiate the change in the focus of video camera 110 to focus on the participant associated with the lip movement parameter that satisfies the threshold. For example, communication device 120 may initiate the change in the focus of video camera 110 to the participant based at least in part on the amount of time of the lip movement of the participant satisfying the threshold. In this case, communication device 120 may initiate the change in the focus of video camera 110 by providing an instruction to zoom in on the participant. Additionally, or alternatively, communication device 120 may initiate the change in the focus of the video feed by modifying the video feed (e.g., to crop the video feed, to perform a digital zoom, pan, or tilt on the video feed, or the like).

In some aspects, communication device 120 may use a timer to prevent initiation of a change in the focus a second time within a threshold amount of time of initiating a change in the focus a first time. In this way, communication device 120 may enhance a user experience by preventing focus from being constantly changed (e.g., to prevent ping-ponging).

Thus, communication device 120 may initiate a change in the focus of the video feed away from multiple participants, on the same end of the video call, to an individual participant associated with lip movement. In this way, communication device 120 may enhance a user experience associated with the video call, such as by enabling a user to determine who is speaking among multiple participants on the same end of the video call, to see the speaker's facial expressions by focusing on an individual speaker rather than multiple speakers, to better understand the speaker, or the like. Further, this may conserve computing resources and/or network resources by permitting shorter video calls when the users can understand one another.

As indicated above, FIG. 3 is provided as an example. Other examples are possible and may differ from what was described above in connection with FIG. 3.

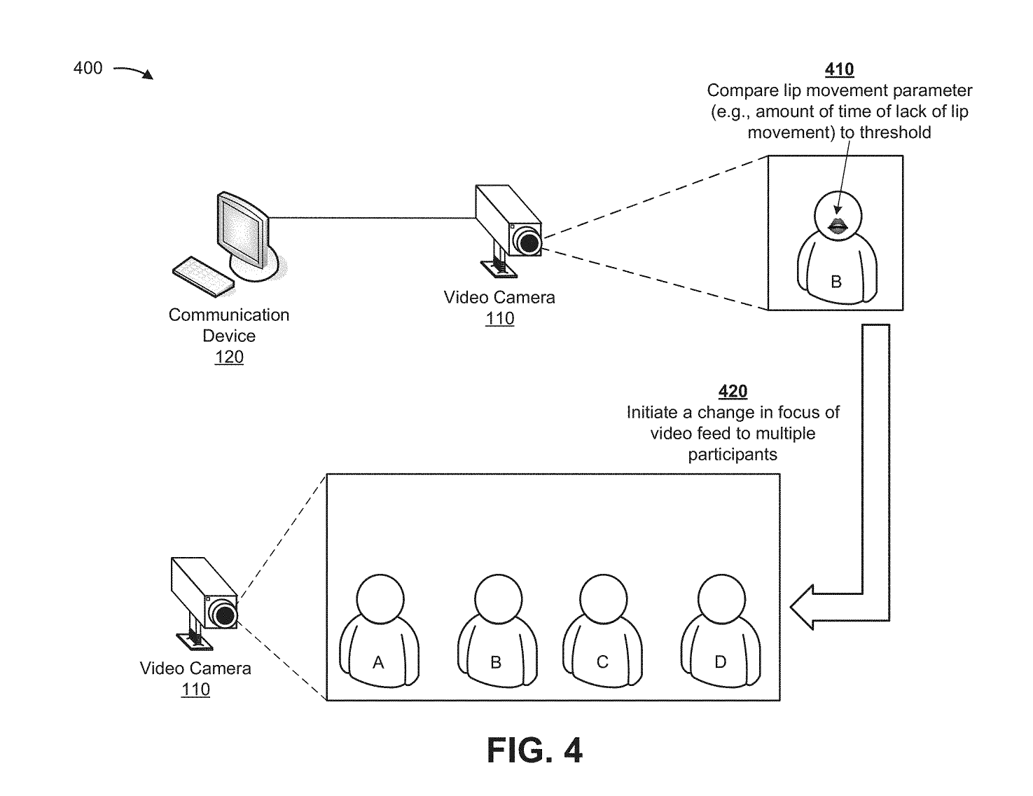

FIG. 4 is a diagram illustrating another example 400 of using lip movement detection for speaker recognition in multi-person video calls, in accordance with various aspects of the present disclosure.

As shown in FIG. 4, video camera 110 may capture a video feed of an individual participant among multiple participant on the same end of a video call, and may provide the video feed (and/or video data for the video feed) to communication device 120. Communication device 120 may provide video data to another communication device 120, via a network, for a video call.

As shown by reference number 410, communication device 120 may determine a lip movement parameter of a participant, of the multiple participants, when video camera 110 is focused on the participant. Communication device 120 may compare the lip movement parameter to a threshold. In some aspects, the lip movement parameter may represent an amount of time of a lack of lip movement of the participant. Additionally, or alternatively, the lip movement parameter may represent a measure of a lack of lip movement of the participant. In this case, communication device 120 may determine the measure of the lack of lip movement based at least in part on, for example, a lip movement recognition algorithm.

In some aspects, communication device 120 may compare the lip movement parameter to a threshold. For example, communication device 120 may determine whether the amount of time of the lack of lip movement satisfies a threshold (e.g., may determine whether the participant's lips have stopped moving for a threshold amount of time). As another example, communication device 120 may determine whether a measure of a lack of lip movement satisfies a threshold (e.g., may determine whether the degree to which the participants lips are moving fails to satisfy the threshold). In some aspects, communication device 120 may calculate a score based at least in part on multiple factors (e.g., an amount of time of a lack of lip movement, a measure of a lack of lip movement, etc.), and may determine whether the score satisfies the threshold. The score may represent a likelihood that a particular participant is the active speaker.

As shown by reference number 420, if communication device 120 determines that the lip movement parameter satisfies the threshold, then communication device 120 may initiate a change in a focus of the video feed. For example, communication device 120 may initiate the change in the focus of the video feed by providing an instruction to video camera 110 to change the focus (e.g., to pan video camera 110, to zoom video camera 110, to tilt video camera 110, to switch to a different video camera 110, or the like). Additionally, or alternatively, communication device 120 may initiate the change in the focus of the video feed from a single participant to multiple participants based at least in part on detecting multiple voices (e.g., using voice recognition) on the same end of the video call. In some aspects, communication device 120 may calculate a score based on a combination of voice recognition and lip movement detection, and may initiate the change in the focus of the video feed when the score satisfies a threshold. The score may represent a likelihood that a particular participant is the active speaker.

As shown, communication device 120 may initiate the change in the focus of video camera 110 away from the participant associated with the lack of lip movement. In some aspects, communication device 120 may initiate the change in the focus of video camera 110 to multiple participants at least two of the participants, all of the participants, etc.). In this case, communication device 120 may initiate the change in the focus of video camera 110 by providing an instruction to zoom out from the participant. In some aspects, communication device 120 may initiate the change in the focus of video camera 110 to multiple participants (e.g., by providing an instruction to zoom out, to pan, to switch to a different camera, etc.) after initiating the change in the focus of video camera 110 to an individual participant (e.g., as described above in connection with FIG. 3). Additionally, or alternatively, communication device 120 may prevent initiation of the change in the focus of video camera 110 away from the participant until the amount of time of the lack of lip movement satisfies a threshold.

In some aspects, communication device 120 may use a timer to prevent initiation of a change in the focus a second time within a threshold amount of time of initiating a change in the focus a first time (e.g., to prevent constant zooming in and zooming out). In this way, communication device 120 may enhance a user experience by preventing focus from being constantly changed (e.g., to prevent ping-ponging).

Thus, communication device 120 may initiate a change in the focus of the video feed away from an individual participant, associated with a lack of lip movement, and to multiple participants on the same end of the video call. In this way, communication device 120 may enhance a user experience associated with the video call, such as by preventing focus on a participant when that participant is not speaking, enabling a user to see an entire group of participants when none of the participants are speaking or when a different participant is speaking, or the like.

As indicated above, FIG. 4 is provided as an example. Other examples are possible and may differ from what was described above in connection with FIG. 4.

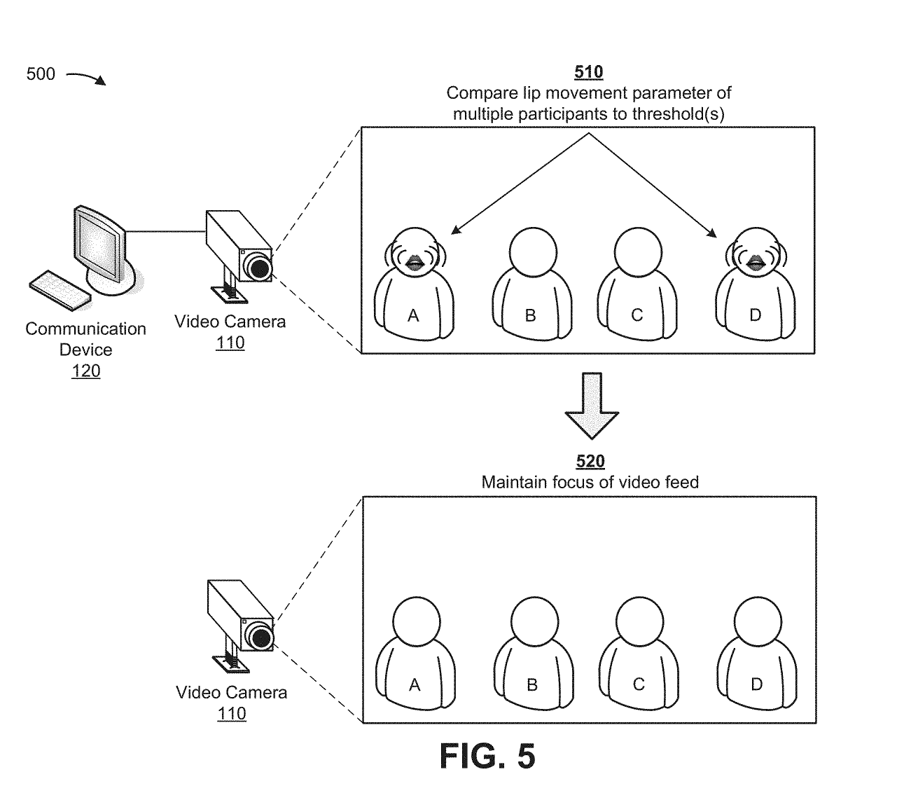

FIG. 5 is a diagram illustrating another example 500 of using lip movement detection for speaker recognition in multi-person video calls, in accordance with various aspects of the present disclosure.

As shown in FIG. 5, video camera 110 may capture a video feed of multiple participants on the same end of a video call, and may provide the video feed (and/or video data for the video feed) to communication device 120. Communication device 120 may provide video data to another communication device 120, via a network, for a video call.

As shown by reference number 510, communication device 120 may determine lip movement parameters corresponding to multiple participants on the video call (e.g., at least two of the participants, all of the participants, etc.), and may compare the lip movement parameters to one or more thresholds. In some aspects, the lip movement parameters may represent an amount of time of the lip movements of the participants. Additionally, or alternatively, the lip movement parameters may represent a measure of an amount of lip movement of the participants. In this case, communication device 120 may determine the measure of the amount of lip movement based at least in part on, for example, a lip movement recognition algorithm. For example, the lip movement recognition algorithm may identify one or more faces, may identify a location of mouths and/or lips on the faces, and may determine whether the mouths and/or lips are moving in a manner indicative of speech.

In some aspects, communication device 120 may compare the lip movement parameters to one or more thresholds. For example, communication device 120 may determine whether the amount of time of lip movement, for multiple participants, satisfies a threshold (e.g., may determine whether the participants' lips have been moving for a threshold amount of time). As another example, communication device 120 may determine whether a measure of an amount of lip movement, for multiple participants, satisfies a threshold (e.g., may determine whether the degree to which the participants' lips are moving satisfies the threshold). In some aspects, communication device 120 may calculate a score based at least in part on multiple factors an amount of time of lip movement, a measure of an amount of lip movement, etc.), and may determine whether the score satisfies the threshold(s).

As shown by reference number 520, if communication device 120 determines that the lip movement parameters satisfy the threshold(s), then communication device 120 may maintain a focus of the video feed (e.g., by preventing initiation of a change in the focus of the video feed). In some aspects, communication device 120 may determine a position of the multiple speakers (e.g., participants with lip movement parameters that satisfy the threshold(s)), and may determine whether to maintain focus or initiate a change in the focus of the video feed based at least in part on the position of the multiple speakers. For example, communication device 120 may determine that the multiple speakers are positioned at the edge of a frame of the video feed (e.g., because communication device 120 does not detect any faces between an active speaker and the edge of a video frame, because the faces of the active speakers are within a threshold distance from the edge of the video frame, etc.). In this case, communication device 120 may maintain the focus of the video feed (e.g., may maintain focus of video camera 110).

Thus, when multiple participants are speaking at the same time, communication device 120 may prevent video camera 110 from focusing on one of the participants, and may focus video camera 110 so as to capture all participants who are speaking. In this way, communication device 120 may enhance a user experience associated with the video call, such as by enabling a user to see multiple active speakers, to follow a dialog between the multiple active speakers, or the like.

As indicated above, FIG. 5 is provided as an example. Other examples are possible and may differ from what was described above in connection with FIG. 5.

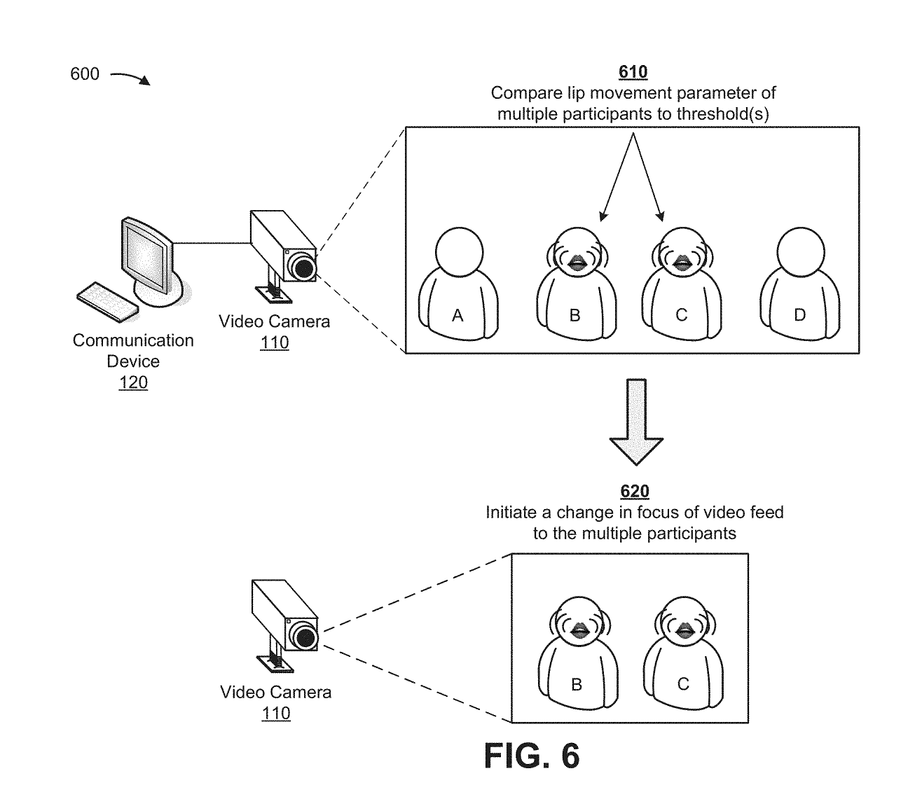

FIG. 6 is a diagram illustrating another example COO of using lip movement detection for speaker recognition in multi-person video calls, in accordance with various aspects of the present disclosure.

As shown in FIG. 6, video camera 110 may capture a video feed of multiple participants on the same end of a video call, and may provide the video feed (and/or video data for the video feed) to communication device 120. Communication device 120 may provide video data to another communication device 120, via a network, for a video call.

As shown by reference number 610, communication device 120 may determine lip movement parameters corresponding to multiple participants on the video call (e.g., at least two of the participants, all of the participants, etc.), and may compare the lip movement parameters to one or more thresholds, in a similar manner as described above in connection with FIG. 5.

As shown by reference number 620, if communication device 120 determines that the lip movement parameters satisfy the threshold(s), then communication device 120 may initiate a change in a focus of the video feed. In some aspects, communication device 120 may determine a position of the multiple speakers (e.g., participants with lip movement parameters that satisfy the threshold(s)), and may determine whether to maintain focus or initiate a change in the focus of the video feed based at least in part on the position of the multiple speakers. For example, communication device 120 may determine that the multiple speakers are not positioned at the edge of a frame of the video feed (e.g., because communication device 120 detects one or more faces between an active speaker and the edge of a video frame, because the faces of the active speakers are not within a threshold distance from the edge of the video frame, etc.). In this case, communication device 120 may initiate a change in the focus of the video feed to focus on the multiple active speakers.

For example, communication device 120 may initiate the change in the focus of the video feed so that the active speakers appear at the edge of the video frame. In some aspects, communication device 120 may initiate the change in the focus of the video feed such that any faces between an active speaker and an edge of the video frame are removed from the video frame (e.g., by zooming, by panning, by tilting, by changing video camera 110, or some combination thereof). Additionally, or alternatively, communication device 120 may initiate the change in the focus of the video feed so that the face of an active speaker is positioned within a threshold distance of the edge of the video frame (e.g., by zooming, by panning, by tilting, by changing video camera 110, or some combination thereof). As described elsewhere herein, communication device 120 may initiate the change in the focus of the video feed by initiating a change in a focus of video camera 110 (e.g., by providing an instruction to video camera 110 to change the focus), by switching a source of the video feed to a different video camera 110, and/or by modifying the video feed (e.g., to crop the video feed, to perform a digital zoom, crop, or tilt, or the like).

Thus, when multiple participants are speaking at the same time, communication device 120 may initiate a change in the focus of the video feed so as to capture all participants who are speaking, and to remove other participants who are not speaking (e.g., so long as those participants are not positioned between the active speakers). In this way, communication device 120 may enhance a user experience associated with the video call, such as by enabling a user to see multiple active speakers, to follow a dialog between the multiple active speakers, or the like.

As indicated above, FIG. 6 is provided as an example. Other examples are possible and may differ from what was described above in connection with FIG. 6.

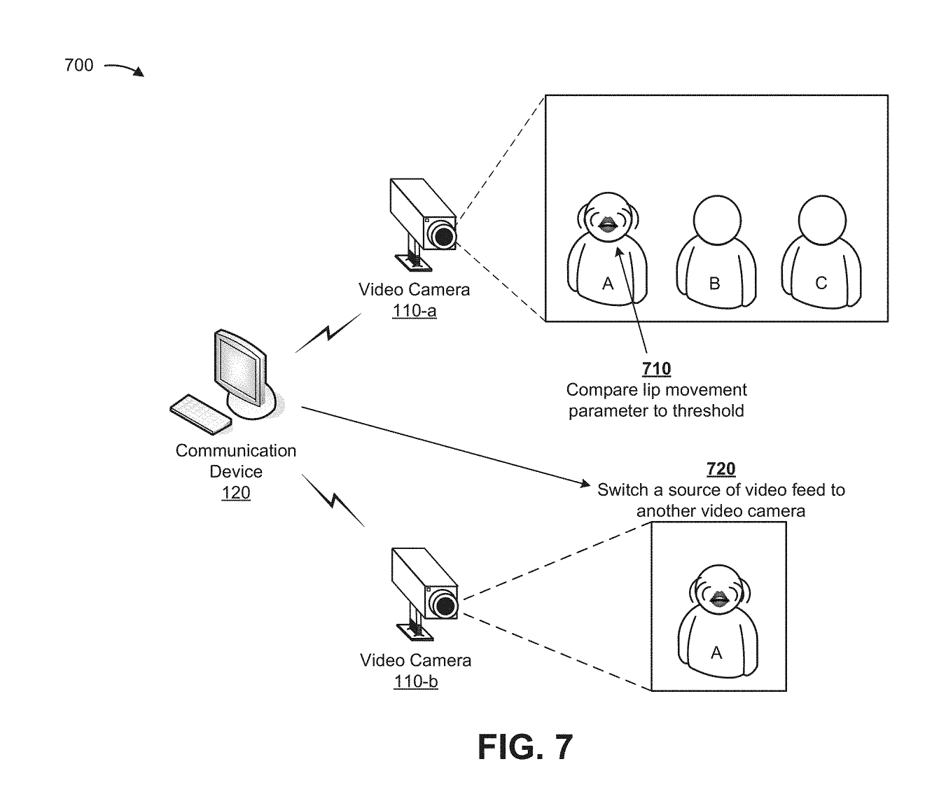

FIG. 7 is a diagram illustrating another example 700 of using lip movement detection for speaker recognition in multi-person video calls, in accordance with various aspects of the present disclosure.

As shown in FIG. 7, communication device 120 may communicate with multiple video cameras 110, shown as video camera 110-a and video camera 110-b. In some aspects, both video cameras 110 may capture video feeds for a video call. For example, video camera 110-a may capture a video feed of multiple participants on the same end of a video call, and video camera 110-b may capture a video feed of fewer than all of the participants (e.g., one participant). In some aspects, one or more video cameras 110 may be fixed (e.g., unable to pan, zoom, tilt, etc.). In some aspects, one or more video cameras 110 may not be fixed (e.g., may be able to pan, zoom, tilt, etc.).

Video cameras 110 may provide respective video feeds (and/or video data for the video feeds) to communication device 120. Communication device 120 may provide video data (e.g., from one of the video feeds) to another communication device 120, via a network, for a video call. In some aspects, communication device 120 may capture video data and/or video feeds from multiple video cameras 110, may analyze the video data and/or video feeds from the multiple video cameras 110, and may select video data and/or a video feed from a particular video camera 110 as a source of the video feed for transmission to another communication device 120 for a video call.

As shown by reference number 710, communication device 120 may determine a lip movement parameter of a participant of the multiple participants, and may compare the lip movement parameter to a threshold, as described elsewhere herein (e.g., in connection with FIGS. 3-6). For example, communication device 120 may analyze a video feed from video camera 110-a to determine the lip movement parameter.

As shown by reference number 720, if communication device 120 determines that the lip movement parameter determined from video camera 110-a satisfies a threshold, then communication device 120 may switch a source of the video feed to video camera 110-b. For example, communication device 120 may switch from providing video data from a video feed from video camera 110-a (e.g., to another communication device 120 on a video call) to providing video data from a video feed from video camera 110-b. In this way, the other communication device 120 on the video call may receive video data for the video feed from video camera 110-b (e.g., showing the participant who is speaking), rather than receiving the video data for the video feed from video camera 110-a (e.g., showing multiple participants, some of which may not be speaking).

As an example, communication device 120 may switch a source of the video feed to video camera 110-b based at least in part on the amount of time of the lip movement of the participant satisfying a threshold. Thus, communication device 120 may switch a source of the video feed to a different video camera 110 to focus on an active speaker among multiple participants on the same end of the video call. In this way, communication device 120 may enhance a user experience associated with the video call, such as by enabling a user to determine who is speaking among multiple participants on the same end of the video call, to see the speaker's facial expressions by focusing on an individual speaker rather than multiple speakers, to better understand the speaker, or the like.

As indicated above, FIG. 7 is provided as an example. Other examples are possible and may differ from what was described above in connection with FIG. 7.

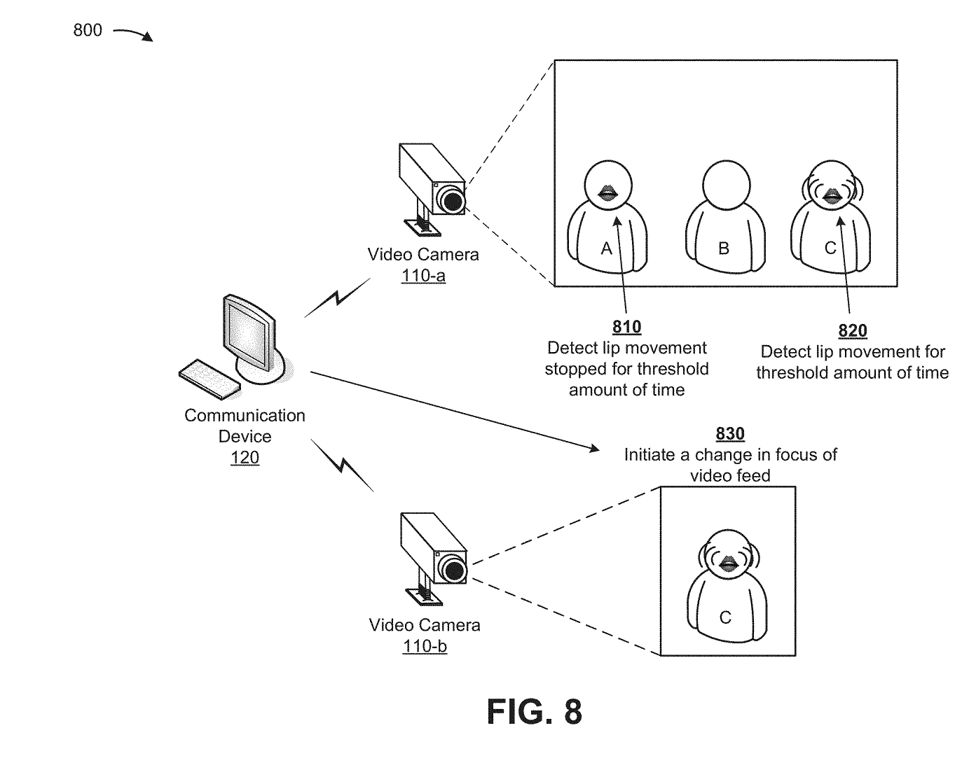

FIG. 8 is a diagram illustrating another example 800 of using lip movement detection for speaker recognition in multi-person video calls, in accordance with various aspects of the present disclosure.

As shown in FIG. 8, communication device 120 may communicate with multiple video cameras 110, shown as video camera 110-a and video camera 110-b, as described above in connection with FIG. 7.

Communication device 120 may monitor video data and/or a video feed from video camera 110-a to determine that a different participant is speaking (e.g., a different participant than participant “A,” shown in FIG. 7). As shown by reference number 810, communication device 120 may determine that a first participant has stopped speaking based at least in part on a lip movement parameter, associated with the first participant, satisfying a threshold (e.g., as described above in connection with FIG. 4). As shown by reference number 820, communication device 120 may determine that a second participant is speaking based at least in part on a lip movement parameter, associated with the second participant, satisfying a threshold (e.g., as described above in connection with FIG. 3).

As shown by reference number 830, if communication device 120 determines that the lip movement parameters determined from video camera 110-a satisfies respective thresholds, then communication device 120 may initiate a change in a focus of video camera 110-b (e.g., a video feed provided by video camera 110-b). For example, communication device 120 may provide an instruction for video camera 110-b to pan to the second participant (e.g., shown as participant “C”). In this way, the other communication device 120 on the video call may receive video data for the video feed from video camera 110-b, which shows the participant who is speaking.

Thus, as described above in connection with FIGS. 3-8, communication device 120 may initiate a change in a focus of video camera(s) 110 and/or a video feed to focus on different speakers or groups of speakers among multiple speakers on a same end of a video call. For example, communication device 120 may initiate a change in the focus of video camera(s) 110 and/or a video feed from a single participant to multiple participants (e.g., all participants, at least two participants, etc.), may initiate a change in the focus of video camera(s) 110 and/or a video feed from multiple participants to a single participant, may initiate a change in the focus of video cameras) 110 and/or a video feed from a first group of multiple participants to a second group of multiple participants, and/or may initiate a change in the focus of video camera(s) 110 and/or a video feed from a first participant to a second participant among the multiple participants.

In some aspects, communication device 120 may use audio input to determine whether to initiate a change in the focus of a video feed. For example, there may be multiple audio input devices (e.g., microphones) on one end of a video call that has multiple participants on that end of the video call. In some aspects, communication device 120 may identify an audio input device that is capturing sound or that is capturing sound at a higher volume level, and may initiate a change in the focus of the video feed based at least in part on a location of that audio input device. Additionally, or alternatively, communication device 120 may use audio input to determine which end of a video call should be the focus, and may use techniques described herein to determine which participant, on that end of the video call, is to be the focus of the video feed.

In this way, communication device 120 may enhance a user experience associated with the video call, such as by enabling a user to determine who is speaking among multiple participants on the same end of the video call, to see the speaker's facial expressions by focusing on an individual speaker rather than multiple speakers, to better understand the speaker, or the like.

As indicated above, FIG. 8 is provided as an example. Other examples are possible and may differ from what was described above in connection with FIG. 8.

FIG. 9 is a diagram illustrating an example process 900 for using lip movement detection for speaker recognition in multi-person video calls, in accordance with various aspects of the present disclosure. In some aspects, one or more process blocks of FIG. 9 may be performed by communication device 120. In some aspects, one or more process blocks of FIG. 9 may be performed by another device or a group of devices separate from or including communication device 120, such as video camera 110.

As shown in FIG. 9, in some aspects, process 900 may include determining a parameter associated with lip movement of a participant included in a plurality of participants on a same end of a video call (block 910). For example, communication device 120 may determine a parameter associated with lip movement of a participant included in a plurality of participants on a same end of a video call. In some aspects, communication device 120 may detect the plurality of participants on the same end of the video call (e.g., using facial recognition, speech recognition, or the like), and may determine the parameter based at least in part on detecting the plurality of participants on the same end of the video call.

In some aspects, the parameter may represent an amount of time of the lip movement of the participant. In some aspects, the parameter may represent a measure of lip movement of the participant. In some aspects, the parameter may represent an amount of time of a lack of the lip movement of the participant. In some aspects, the parameter may represent a measure of a lack of lip movement of the participant. In some aspects, communication device 120 may determine multiple parameters corresponding to lip movements of multiple participants of the plurality of participants. Communication device 120 may use the parameter(s) in association with determining whether to switch focus of a video feed of a video call (e.g., to an active speaker).

As further shown in FIG. 9, in some aspects, process 900 may include comparing the parameter to a threshold (block 920). For example, communication device 120 may compare the parameter to a threshold. In some aspects, the threshold may represent an amount of time. In some aspects, the threshold may indicate a measure of a degree of lip movement or a lack of lip movement. In some aspects, communication device 120 may determine multiple parameters corresponding to lip movements of multiple participants, and may compare the multiple parameters to corresponding threshold.

In some aspects, communication device 120 may compare a parameter to a threshold by determining whether the parameter is greater than a threshold, determining whether the parameter is greater than or equal to a threshold, determining whether the parameter is less than a threshold, determining whether the parameter is less than or equal to a threshold, determining whether the parameter is equal to a threshold, determining whether the parameter is within a threshold range, or some combination thereof (e.g., determining whether the parameter is greater than a first threshold and less than a second threshold).

As further shown in FIG. 9, in some aspects, process 900 may include initiating a change in a focus associated with a video feed of the video call based at least in part on the comparison of the parameter to a threshold (block 930). For example, communication device 120 may selectively initiate a change in a focus of a video feed associated with the video call based at least in part on the comparison of the parameter to the threshold. In some aspects, communication device 120 may initiate the change in the focus of the video feed. In some aspects, communication device 120 may maintain focus of the video feed by preventing an initiation of a change in the focus of the video feed. For example, communication device may prevent initiation of a change in the focus of the video feed away from a participant until an amount of time of a lack of lip movement of the participant satisfies a threshold.

In some aspects, communication device 120 may initiate a change in the focus of the video feed by initiating a change in a focus of video camera 110. For example, communication device 120 may provide an instruction to video camera 110 to change focus. The instruction may indicate, for example, to zoom video camera 110 (e.g., zoom in or zoom out), to pan video camera 110 (e.g., to pan left or pan right), to tilt video camera 110 (e.g., to tilt up or tilt down), or some combination thereof.

Additionally, or alternatively, communication device 120 may initiate the change in the focus of the video teed by switching to a different video camera 110. For example, for a video call, communication device 120 may switch from providing a first video feed, from a first video camera 110, to providing a second video feed from a second video camera 110. In some aspects, communication device 120 may switch to a different video camera 110 in combination with zooming, panning, tilting, or the like.

In some aspects, communication device 120 may initiate the change in the focus of the video feed by modifying the video feed. For example, communication device 120 may crop the video feed, may digitally zoom in or zoom out on the video feed, may digitally pan left or right on the video feed, may digitally tilt up or down on the video feed, may mask a portion of the video feed, may select one or more portions (e.g., contiguous portions or non-contiguous portions) of the video feed for transmission for the video call, or the like.

In some aspects, communication device 120 may initiate the change in the focus of the video feed to a participant based at least in part on an amount of time of lip movement, associated with the participant, satisfying a threshold. In some aspects, communication device 120 may initiate the change in the focus of the video feed to multiple participants based at least in part on comparing multiple parameters to one or more corresponding thresholds. In some aspects, communication device 120 may initiate the change in the focus of the video feed away from a participant and to multiple participants of the plurality of participants on the same end of the video call. In some aspects, communication device 120 may initiate the change in the focus of the video feed away from multiple participants, of the plurality of participants, and to the participant. In some aspects, communication device 120 may initiate the change in the focus of the video feed away from a first participant and to a second participant.

Techniques described herein permit communication device 120 to focus a video teed on one or more actively speaking participants when there are multiple participants on the same end of the video call. In this way, communication device 120 may enhance a user experience associated with the video call, such as by enabling a user to determine who is speaking among multiple participants on the same end of the video call, to see the speaker's facial expressions by focusing on an individual speaker rather than multiple speakers, to better understand the speaker, or the like.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based at least in part on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. As an example, “at least one of: a, b, or c” is intended to cover: a; b; c; a and b; a and c; b and c; and a, b and c.

No element, act, or instruction used herein should be construed as critical or essential unless explicitly described as such. Also, as used herein, the articles “a” and “an” are intended to include one or more items, and may be used interchangeably with “one or more.” Furthermore, as used herein; the terms “set” and “group” are intended to include one or more items (e.g., related items, unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based at least in part on” unless explicitly stated otherwise.

1. A method, comprising:
determining, by a device, a parameter associated with lip movement of a participant included in a plurality of participants on a same end of a video call,
the parameter representing at least one of an amount of time of the lip movement of the participant or an amount of time of a lack of the lip movement of the participant;
comparing, by the device, the parameter to a threshold; and
initiating, by the device, a change in a focus associated with a video feed of the video call based at least in part on the comparison of the parameter to the threshold.

2. The method of claim 1, further comprising:
detecting the plurality of participants on the same end of the video call; and
determining the parameter based at least in part on the plurality of participants as detected.

3. The method of claim 1, wherein the parameter represents the amount of time of the lip movement of the participant; and
wherein initiating the change in the focus associated with the video feed of the video call further comprises:
initiating the change in the focus associated with the video feed of the video call to the participant based at least in part on the amount of time of the lip movement of the participant satisfying the threshold.

4. The method of claim 1, wherein the parameter represents the amount of time of the lack of the lip movement of the participant; and
wherein initiating the change in the focus associated with the video feed of the video call further comprises:
preventing an initiation of the change in the focus associated with the video feed away from the participant until the amount of time of the lack of the lip movement satisfies the threshold.

5. The method of claim 1, further comprising:
determining multiple parameters corresponding to lip movements of multiple participants of the plurality of participants,
the multiple parameters including the parameter;
comparing the multiple parameters to one or more corresponding thresholds,
the one or more thresholds including the threshold; and
initiating the change in the focus associated with the video feed to the multiple participants based at least in part on the comparison of the multiple parameters to the one or more corresponding thresholds.

6. The method of claim 1, further comprising:
wherein initiating the change in the focus associated with the video feed of the video call further comprises:
initiating the change in the focus associated with the video feed away from the participant and to one or more other participants of the plurality of participants.

7. The method of claim 1, further comprising:
initiating the change in the focus associated with the video feed away from multiple participants of the plurality of participants, and to the participant.

8. The method of claim 1, wherein initiating the change in the focus associated with the video feed of the video call further comprises:
initiating the change in the focus associated with the video feed away from a first participant, of the plurality of participants, and to a second participant of the plurality of participants,
the participant corresponding to the first participant or the second participant.

9. The method of claim 1, wherein initiating the change in the focus associated with the video feed of the video call further comprises:
initiating the change in the focus associated with the video feed, at least in part, by initiating a change that:
zooms a camera, or
pans the camera, or
switches a source of the video feed from the camera to another camera, or
modifies the video feed, or
some combination thereof.

10. A device, comprising:
one or more processors to:
determine a parameter associated with lip movement of a participant included in a plurality of participants on a same end of a video call,
the parameter representing at least one of an amount of time of the lip movement of the participant or an amount of time of a lack of the lip movement of the participant;
compare the parameter to a threshold; and
initiate a change in a focus associated with a video feed of the video call based at least in part on the comparison of the parameter to the threshold.

11. The device of claim 10, wherein the parameter further represents at least one of:
a measure of the lip movement of the participant, or
a measure of the lack of the lip movement of the participant, or
some combination thereof.

12. The device of claim 10, wherein the one or more processors are further to:
determine multiple parameters corresponding to lip movements of multiple participants of the plurality of participants,
the multiple parameters including the parameter;
compare the multiple parameters to one or more corresponding thresholds,
the one or more corresponding thresholds including the threshold; and
initiate the change in the focus associated with the video feed to the multiple participants based at least in part on the comparison of the multiple parameters to the one or more corresponding thresholds.

13. The device of claim 10, wherein the one or more processors, when initiating the change in the focus associated with the video feed of the video call, are further to at least one of:
initiate the change in the focus associated with the video feed away from the participant and to one or more other participants of the plurality of participants;
initiate the change in the focus associated with the video feed away from multiple participants of the plurality of participants, and to the participant; or
initiate the change in the focus associated with the video feed away from a first participant, of the plurality of participants, and to a second participant of the plurality of participants,
the participant corresponding to the first participant or the second participant.

14. The device of claim 10, wherein the one or more processors, when initiating the change in the focus associated with the video feed of the video call, are further to:
initiate the change in the focus associated with the video feed, at least in part, by initiating a change that:
zooms a camera, or
pans the camera, or
switches a source of the video feed from a the camera to another camera, or
modifies the video feed, or
some combination thereof.

15. A non-transitory computer-readable medium storing instructions, the instructions comprising:
one or more instructions that, when executed by one or more processors of a device, cause the one or more processors to:
determine a parameter associated with lip movement of a participant included in a plurality of participants on a same end of a video call,
the parameter representing at least one of an amount of time of the lip movement of the participant or an amount of time of a lack of the lip movement of the participant;
compare the parameter to a threshold; and
initiate a change in a focus associated with a video feed of the video call based at least in part on the comparison of the parameter to the threshold.

16. The non-transitory computer-readable medium of claim 15, wherein the parameter represents the amount of time of the lip movement of the participant; and
wherein the one or more instructions, that cause the one or more processors to initiate the change in the focus associated with the video feed of the video call, cause the one or more processors to:
initiate the change in the focus associated with the video feed to the participant based at least in part on the amount of time of the lip movement of the participant satisfying the threshold.

17. The non-transitory computer-readable medium of claim 15, wherein the one or more instructions, that cause the one or more processors to initiate the change in the focus associated with the video feed of the video call, cause the one or more processors to:
initiate the change in the focus associated with the video feed away from the participant and to one or more other participants of the plurality of participants.

18. The non-transitory computer-readable medium of claim 15, wherein the one or more instructions, that cause the one or more processors to initiate the change in the focus associated with the video feed of the video call, cause the one or more processors to:
initiate the change in the focus associated with the video feed away from multiple participants of the plurality of participants, and to the participant.

19. The non-transitory computer-readable medium of claim 15, wherein the one or more instructions, that cause the one or more processors to initiate the change in the focus associated with the video feed of the video call, cause the one or more processors to:
initiate the change in the focus associated with the video feed away from a first participant, of the plurality of participants, and to a second participant of the plurality of participants,
the participant corresponding to the first participant or the second participant.

20. The non-transitory computer-readable medium of claim 15, wherein the one or more instructions, that cause the one or more processors to initiate the change in the focus associated with the video feed of the video call, cause the one or more processors to:
initiate the change in the focus associated with the video feed based, at least in part, by initiating a change that:
zooms a camera, or
pans the camera, or
switches a source of the video feed from the camera to another camera, or
modifies the video feed, or
some combination thereof.
